(19) United States
(12) Patent Application Publication
(10) Pub. No.: US 2021/0147133 A1
(43) Pub. Date: May 20, 2021

(54) Individual blister pack, packaging machine and method for producing an individual blister pack

(71) Applicant: 7 DS ENGEENIERING BV, Zevenaar (NL)

(72) Inventor: Detlef STEINWEG, Castrop-Rauxel (DE)

(73) Assignee: 7 DS ENGEENIERING BV, Zevenaar (NL)

(21) Appl. No.: 16/645,302

(22) PCT Filed: Sep. 7, 2018
(86) PCT No.: PCT/EP2018/074178

§ 371 Date: Mar. 6, 2020

(30) Foreign Application Priority Data
Sep. 8, 2017 (DE) 10 2017 215 917.0

(51) Int. Cl. B65D 75/32; A61J 1/03; B65B 5/10; B65B 7/16; B65B 9/04; B65B 39/00; B65D 75/52

(52) U.S. Cl. CPC B65D 75/327; A61J 1/035; B65B 5/103; B65B 7/164; B65B 2210/06; B65B 39/007; B65D 75/527; B65D 2585/56; B65B 9/045

(57) ABSTRACT

The disclosure relates to an individual blister packaging for drug administration, in particular a blister card, comprising a carrier, wherein the carrier has a plurality of recesses arranged in a matrix-like manner, and a cover film for closing the filled recesses, wherein at least two recesses are provided substantially independently from each other and, in particular, are connected to one another only by the cover film and/or a defined number of connection points.

### TECHNICAL FIELD

The present disclosure relates to an individual blister pack for medication administration, in particular a blister card. Furthermore, the present disclosure relates to a packaging machine for producing individual blister packs for medication administration and a method for producing an individual blister pack for medication administration.

### BACKGROUND

Blister packs are generally known. A distinction is substantially made between bag-like tube blisters and flat, substantially dimensionally stable, card blisters. It is also known to fill and close such a card blister with medications according to the prescription of a physician for the individual patient for several days and optionally multiple administration times, so that the patient only has to consume all of the medications in a recess on schedule at each administration time.

However, it is disadvantageous in that no flexibility is possible, since prefabricated carriers having a predetermined matrix of recesses (for example, in the form of a 7×2 matrix, for example, thus 14 recesses for 2 administration times on 7 days) are used. Furthermore, such individual patient packaging is often at least partially done manually. Cross-contamination occurs in known packaging machines, due to the contact of medication-carrying parts of the packaging machine with various medications. In addition, known packaging machines take up a large amount of space and are expensive, so that such packaging machines have up to now only been used in so-called blister centers.

### SUMMARY

It is therefore an object of the present disclosure to provide a flexible, individual blister pack and a packaging machine for producing such blister packs, which machine can be operated flexibly and with little space requirement while avoiding cross-contamination and which can preferably also be used on site.

This object is achieved, among other things, using an individual blister pack for medication administration, in particular a blister card, having a carrier, wherein the carrier has a plurality of recesses arranged in a matrix-like manner, and a cover film for closing the filled recesses, wherein at least two recesses are provided substantially independently of one another and, in particular, are only connected to one another by the cover film and/or a defined number of connection points.

The statements relating to this subject of the present disclosure also apply to the other subjects and vice versa.

An individual blister pack therefore consists at least of a carrier having recesses into which medications are placed and a cover film which preferably closes the recesses airtight. According to the disclosure, it is now provided that at least some of the recesses are provided independently of one another. Due to the fact that the recesses are at least partially independent of one another, that is, that at least some of the recesses are preferably connected to one another only via the cover film, the length of the carrier and thus the number of recesses can be flexibly adjusted to provide the appropriate blister pack for each patient, which is advantageous during the production of the blister pack, in particular still during the filling process. In particular, this makes it particularly advantageously possible to dispense with a plurality of different, prefabricated carriers, whereby storage is thus improved and an arbitrarily large number of different blister packs can be produced.

In the context of this disclosure, an individual blister pack is intended to mean both a blister pack individually tailored to a patient and a blister pack individually tailored to a plurality of patients. For example, according to the disclosure, it is understood that a blister pack contains a recess having medications for a specific patient for each day of the week and optionally several administration times, and that, for example, several recesses contain medications for different patients. It is thus advantageously possible that, for example, the ward's needs in a hospital are covered by a blister pack according to the disclosure. The recesses of the carrier matrix can then be associated with a patient in each column and to a day and/or an administration time in each row.

The respective carrier in this case can be made available by different machines and can have, for example, a tablet, a powder, an ointment and/or a liquid.

According to a preferred embodiment, it is provided that the recesses are deep drawn from a film, in particular immediately before filling with medications. In this way, it is advantageously possible to further improve the storage, since only a film and a forming tool are thus required. The forming tool in this case is preferably provided interchangeably in order to implement different carrier types, in particular different matrix shapes. Deep drawing is also a well-known and well-tried process, so that the carrier can be reliably produced using simple and known means.

According to a preferred embodiment, it is provided that the recesses have a circular, oval, rectangular, square or polygonal cross-section in the plane of the cover film. This advantageously makes it possible to produce any desired shape of the recesses. A rounded, in particular a circular or an oval, cross-section is particularly advantageous in this case, since the stability of the recess is increased in this way.

According to a preferred embodiment or a further subject of the present disclosure, it is provided that the recesses are arranged in the form of at least one 1×n, 2×n, 3×n, 4×n, 5×n or 7×n matrix, wherein n is a positive integer, including countable infinity, wherein preferably two rows of the matrix are provided substantially independently of one another. n is particularly preferably 2, 3, 4, 5, 6, 7 or 10. This means that the recesses are arranged in the form of a matrix having a fixed number of columns and a substantially arbitrary number of rows or vice versa. In this case, each column is preferably associated with a day, for example, a day of the week, and each row particularly preferably corresponds to a specific administration time, for example, in the morning, noon and evening. The carrier is preferably provided, for example, as individual rows of recesses, for example, 7×1 vectors or matrices, and the required number of rows is connected to one another by the cover film. This makes it possible, for example, to provide a blister pack having medications for each day of the week and three administration times, for example, in the morning, noon and evening. Such a blister pack then has the shape of a 7×3 matrix.

According to a preferred embodiment, it is provided that the carrier and/or the cover film is printed, particularly preferably with patient information (for example, name, date of birth and/or address of the patient), medication information (for example, the name of the medication, active ingredients, instructions for use, best before dates), and/or advertising information (for example, name and address of the pharmacy). As a result, it is advantageously possible to provide important information directly on the blister pack and thus to dispense with separate information such as leaflets or the like.

According to the disclosure, it is provided that the recesses are provided at least partially independently of one another and, in particular, are only connected to one another by the cover film and/or a defined number of connection points. This should comprise both that several recesses are produced separately from one another and are indirectly connected to one another by the cover film and that the recesses are produced connected, for example, by deep drawing, and then, for example, are mechanically separated and connected to one another by the cover film.

According to a preferred embodiment, it is provided that the recesses are provided separable from one another by punchings and/or perforations. The recesses of a row are preferably provided separable from one another by punchings and/or perforations, and multiple of rows are substantially connected to one another only by the cover film. Alternatively or additionally, the individual rows of the carrier are connected to one another by isolated connection points. This advantageously enables simple isolation of the recesses.

A further subject of the present disclosure is a packaging machine for the production of, in particular, individual blister packs according to the disclosure for medication administration, wherein the packaging machine comprises a filling station having a plurality of containers, wherein each container is provided for storing and dispensing a predetermined medication, wherein the packaging machine has a conveying device, wherein the conveying device is provided for conveying a carrier of a blister pack, wherein the packaging machine is configured such that, in the filling station, the medications can be, in particular directly, filled from the containers into the recesses of the carrier. In comparison with known packaging machines, the main advantages of the packaging machine according to the disclosure are that the medications are filled into the recesses as immediately as possible, that is, directly, thereby eliminating cross-contamination. In any case, a transfer device, for example, a slide or a funnel, over which several different medications are moved, is avoided. A packaging machine according to the disclosure is also referred to as an automatic blister. The packaging machine preferably comprises a control unit which controls the individual parts of the packaging machine. The control unit is particularly preferably connected to at least one detection device in order to check for correct functioning. The data of the detection device are very particularly preferably entered into a feedback loop of the control unit.

The statements relating to this subject of the present disclosure also apply to the other subjects and vice versa.

The person skilled in the art recognizes that in the case of a matrix-like arrangement of the recesses, the medications must be associated with the individual recesses. According to a preferred embodiment, this is achieved by the carrier and/or the containers being arranged to be movable transversely to the conveying direction. The container and the recess are thus aligned relative to one another in order to enable exact filling. For this purpose, the packaging machine preferably comprises a detection device which monitors the relative movement of the container and carrier.

According to a preferred embodiment, it is provided that the container is set up to dispense a predetermined number of medications. The packaging machine particularly preferably comprises at least one measuring device for measuring the fill level of at least one of the containers. As a result, it is advantageously possible to automatically dispense precisely dosed quantities of medication and to recognize at an early stage when a container has to be refilled or replaced.

According to a preferred embodiment or a further subject of the present disclosure, it is provided that the conveying device is provided for conveying at least one movable transport container, wherein the packaging machine is configured such that, in the filling station, the medications, can be filled, in particular directly, from the containers into the transport container, wherein the packaging machine comprises a transfer station, wherein the packaging machine is configured such that, in the transfer station, the medications can be transferred from the movable transport container into a recess of a carrier of a blister pack, in particular according to the disclosure, associated with the transport container. As a result, it is advantageously possible according to the disclosure for the medications to be collected via individually movable transport containers and then transferred into the recesses. Since the transport containers are movable, the containers are preferably arranged in a stationary manner. This simplifies the construction of the packaging machine according to the disclosure and avoids errors, since the filling openings of the transport containers can be larger than the comparatively small openings of the recesses. The packaging machine preferably comprises a plurality of movable transport containers, whereby the cycle speed of the packaging machine is advantageously increased. The packaging machine particularly preferably comprises at least as many transport containers as the carrier has recesses arranged next to one another, that is, in particular, that the number of transport containers corresponds to the number of columns of the carrier, particularly preferably twice the number of columns. It is thus advantageously possible to fill a row of recesses simultaneously and, optionally, to have the transport containers which are associated with the next row already filled by the containers during the filling of the recesses.

According to a preferred embodiment of the present disclosure, it is provided that the conveying device is a conveyor belt, in particular an endless conveyor belt. The conveying device particularly preferably comprises at least one guide rail and a drive, in particular a magnetic drive. The transport containers are very particularly preferably substantially autonomous and movable on the conveying device independently of one another.

According to a preferred embodiment of the present disclosure, it is provided that the packaging machine comprises a sealing station, wherein the sealing station is arranged immediately after the filling station or the transfer station, wherein the sealing station is set up to seal a cover film onto the carrier. This makes it possible for the risk of cross-contamination to be further reduced and to improve the hygiene of the machine in a particularly advantageous manner. The sealing station is particularly preferably arranged such that the filled recesses are immediately closed by the cover film.

According to a preferred embodiment of the present disclosure, it is provided that the packaging machine comprises a separating device for separating a predetermined length of the blister pack and/or the carrier, wherein the separating device is arranged before or after the filling station, the transfer station and/or the sealing station. This advantageously makes it possible to further increase the flexibility with regard to different blister pack sizes.

According to a preferred embodiment of the present disclosure, it is provided that the packaging machine comprises a cleaning station, wherein the cleaning station is arranged, in particular immediately, after the transfer station, wherein the cleaning station is set up for, in particular automatically, cleaning the at least one transport container and/or the containers. The packaging machine is particularly preferably configured such that each transport container is cleaned, in particular sterilized and/or disinfected, immediately after the medication has been transferred to the recess. This further reduces the risk of cross-contamination in a particularly advantageous manner. Thanks to thorough cleaning, it is possible to use the transport container several times without the risk of contamination.

According to a preferred embodiment of the present disclosure, it is provided that the packaging machine comprises a printing station, wherein the printing station is set up to print information on the cover film and/or the carrier. The printing station is particularly preferably arranged before or after the filling station or the sealing station.

According to a preferred embodiment of the present disclosure, it is provided that the containers are provided, in particular automatically, interchangeably and/or fillable. As a result, it is advantageously possible to increase the space requirement and the flexibility of the packaging machine. For example, rarely needed medications may only be used in the packaging machine when needed. Furthermore, simple and hygienic refilling of the containers is made possible, in particular without the packaging machine having to come to a standstill, since the container can be exchanged for a further container.

A further subject of the present disclosure is a method for producing a, in particular, individual blister pack according to the disclosure for medication administration, wherein, in a first step, a carrier is provided with a plurality of recesses arranged in a matrix-like manner, wherein the recesses are automatically filled with medications in a second step, wherein, in a third step, immediately after filling, a cover film is sealed onto the carrier, wherein preferably at least two recesses are connected substantially only by the cover film. Substantially here means in particular that a connection of the recesses should also be understood as isolated connections, for example, connecting bridges.

The statements relating to this subject of the present disclosure also apply to the other subjects and vice versa.

According to a preferred embodiment of the present disclosure, it is provided that in the second step, the medications are filled directly into the recesses through the containers or that in a first sub-step of the second step, the medications are placed in at least one movable transport container and wherein in a second sub-step, the medications are transferred from the transport container into at least one predetermined recess in the carrier. Cross-contamination is advantageously avoided in this way, since the medications are placed directly in the recesses or in a transport container, wherein the transport container transfers the medications into the recesses and is then preferably cleaned.

According to a preferred embodiment of the present disclosure, it is provided that the method is carried out using a packaging machine according to the disclosure. As a result, the method is advantageously implemented in a particularly simple manner and the advantages specified with regard to the packaging machine are achieved.

According to a preferred embodiment, it is provided that the at least one movable transport container is cleaned, particularly preferably disinfected and very particularly preferably sterilized, immediately after the medication has been transferred to the recess.

### BRIEF DESCRIPTION OF THE DRAWINGS

The invention is explained below with reference to FIGS. 1 to 3. These explanations are only examples and do not restrict the general idea of the invention. The explanations apply equally to the individual blister pack according to the disclosure, the packaging machine according to the disclosure and the method according to the disclosure. The same parts are designated with the same reference numerals.

FIG. 1 shows a blister pack.

FIG. 2 shows a packaging machine.

FIG. 3 shows a packaging machine according to a further embodiment.

### DETAILED DESCRIPTION

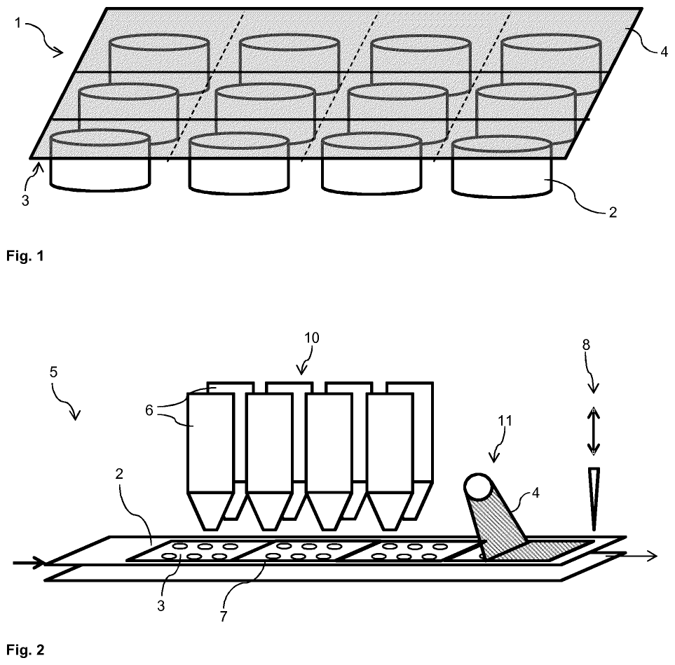

FIG. 1 illustrates a blister pack 1 according to an exemplary embodiment of the present disclosure. In this case, an already packaged individual blister pack 1, that is, one filled with medications and sealed with a cover film 4, is illustrated here. In this case, for the sake of simplicity, the individual blister pack 1 is referred to below as blister pack 1.

In this context, individual means tailored to a specific patient or a specific patient group. In particular, it should be individualized for the patient (that is, the entire blister pack 1 is produced according to the prescription for an individual patient) and individualized for the ward (that is, the blister pack 1 comprises medications for several patients in a hospital ward). A blister pack 1 individualized for a family is also conceivable, for example, if several family members or members of a household have been prescribed medication. In the case of blister packs for a plurality of patients, the rows or columns of the matrix-like arrangement are preferably associated with individual patients.

The blister pack 1 comprises a carrier 3, in which recesses 2 are provided, for example, molded in one piece. The carrier 3 together with the recesses 2 is in this case preferably produced from a film by deep drawing. The carrier 3 preferably comprises a plastic material.

The recesses 2 can be designed in any way. Rounded recesses 2 having a substantially oval cross-section in the plane of the cover film 4 are customary. A variant is illustrated having substantially cylindrical recesses 2, that is, a circular cross-section. A hemispherical shape of the recesses 2 is also conceivable. This enables a stable shape that can safely simultaneously accommodate several medications, even of different sizes. The recesses 2 are arranged in a matrix-like manner, that is, on a grid in rows and columns.

At least two recesses 2 of the carrier 3 are provided substantially independently of one another. This should be understood to mean that at least two recesses 2 are connected to one another substantially only by the cover film 4, or that there are only a few individual connection points, for example, a connecting bridge of small width. The individual series or rows of the matrix formed by the recesses 2 are preferably largely or completely independent of one another (apart from the cover film 4).

The carrier 3 here has a fixed number of columns, for example, seven columns, corresponding to seven recesses 2 arranged next to one another (for example, for seven days of the week), and a certain number of rows, that is, recesses 2 arranged one after the other. The rows correspond, for example, to different administration times, such as in the morning, noon and/or evening.

During the production of the blister pack 1, a number of recesses 2 suitable according to the individual requirements is then composed and connected to one another by the cover film 4, and thus a matrix having a specific (finite) matrix size is generated.

In the example illustrated, a blister pack 1 individualized for the patient is provided for four days and three administration times per day. According to the embodiment illustrated, this is composed of three rows of four recesses 2, wherein the rows are connected to one another by the cover film 4 and, optionally, individual connection points, for example, connecting bridges. The finished blister pack 1 thus has 12 recesses, which are arranged in the form of a 4×3 matrix or 3×4 matrix.

The cover film 4 is preferably sealed immediately after being filled with medications in order to avoid possible contamination and/or cross-contamination.

Such a blister pack 1 is similar, for example, to known condensed milk blister packs, in which individual cylindrical packages are connected to circular cover films 4 at very few points and can be easily separated.

Blister packs 1 of any size can thus be provided in accordance with medical requirements by suitably providing the recesses 2, for example, in the form of rows having seven recesses 2 arranged next to one another and optionally connected directly or indirectly (through the cover film 4) to one another.

The medications in this case can be in tablet, pill, liquid and/or powder form and can be filled into the recesses 2.

The cover film 4 is preferably made of a plastic and/or a metal, in particular aluminum. The cover film 4 is particularly preferably made of an aluminum-plastic composite.

FIG. 2 illustrates a packaging machine 5 according to an embodiment of the present disclosure. Only a section of the packaging machine 5 is illustrated schematically here. Coming from the left, a conveying device 7, for example, an endless conveyor belt, transports an (endless) carrier 3 having recesses 2 arranged in a matrix-like manner along a, here linear, conveying direction.

The packaging machine 5 comprises a control unit, not shown here, which monitors and controls the operation of the packaging machine 5.

A plurality of containers 6 is arranged in a filling station 10, each of which contains a predetermined medication. If a container 6 is arranged exactly above a recess 2 into which the medication contained in the container 6 is to be filled in accordance with the patient's individualized specification which the control unit can detect, for example, by means of a corresponding detection device, a predetermined amount of the medication is filled into the recess 2. Aids such as funnels or other filling aids can be used for this purpose. It is only important that these filling aids are not used for containers 6 with different medications in order to avoid cross-contamination.

Various alternatives are conceivable for filling each of the recesses 2 with the correct medications. According to one embodiment, the containers 6 are displaceable at least transversely to the conveying direction. According to an additional or alternative embodiment, the carrier 3 is at least partially displaceable transversely to the conveying direction. Alternatively or additionally, filling aids are provided such that the medication can be filled from a container 6 into one or more recesses 2 in a targeted manner.

After all recesses 2 have been filled with medications in accordance with the patient's individualized specifications, the cover film 4 is sealed onto the carrier 3 in a sealing station 11, as soon as possible after the last filling. The recesses 2 are hygienically closed as a result. The cover film 4 is unwound from a roll, for example, and sealed by ultrasound or heat. For the sake of simplicity, no sealing tool is illustrated here.

In the present case, a separating device 8 is arranged after the sealing station 11, which separating device separates the different blister packs 1 from one another and/or separates the cover film 4.

Also not illustrated is a printing station in which the cover film 4 and/or the carrier 3 can be printed with relevant information. This printing station can be arranged before or after the filling station 10 or the sealing station 12.

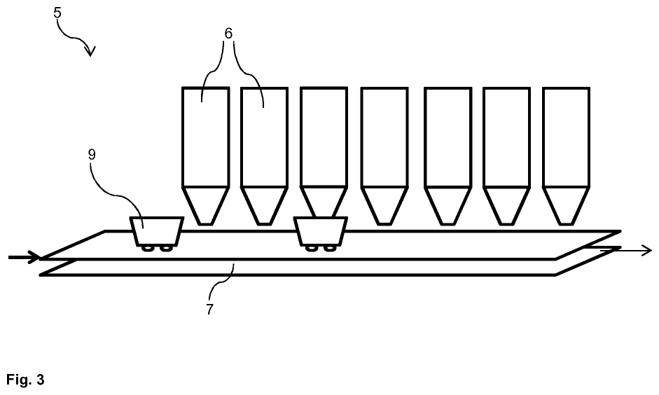

FIG. 3 illustrates a packaging machine 5 according to a further embodiment of the present disclosure. In contrast to the embodiment described in connection with FIG. 2, the recesses 2 are not filled directly with the medications from the containers 6 here, but are first filled into movable transport containers 9. The transport containers 9 can be moved by the conveying device 7 or they can be automatically movable independently of one another, wherein the conveying device 7 can provide a drive, for example, a magnetic drive, or merely form a guide for the transport containers 9.

The transport containers 9 are filled by the containers 6, wherein this is easier than when the recesses 2 are filled directly, due to an opening adapted to the containers 6 or at least one larger opening compared to the opening of the recesses 2.

The transport containers 9 can assume a plurality of possible shapes, for example, a shape similar to a wagon.

Downstream of the filling station 10 a transfer station—not illustrated here—is provided, in which the medications collected in the transport containers 9 are transferred into the respective recesses 2. It is clear to the person skilled in the art that a transport container 9 is preferably associated with each recess 2 for correct dosing.

As in the previously described embodiment, a sealing station 11 is provided immediately following the transfer station in order to close the recesses 2.

Furthermore, a cleaning station, likewise not illustrated, is preferably provided, in which the transport containers 9 are cleaned, preferably disinfected and particularly preferably sterilized, in order to avoid possible cross-contamination during subsequent use.

The cleaning station is particularly preferably arranged immediately after the transfer station in order to avoid possible cross-contamination.

According to a preferred embodiment, it is provided that the number of transport containers 9 corresponds at least to the number of recesses 2 in one row, particularly preferably in two rows, in order to increase the cycle speed. For example, in a 7×3 matrix-like blister pack 1, at least seven, better 14 and very particularly preferably 21 transport containers 9 are provided. In particular, a high process speed of the packaging machine 5 is achieved when the number of transport containers 9 corresponds at least to the number of recesses 2 of a blister pack 1.

### LIST OF REFERENCE NUMBERS

1 blister pack
2 recess
3 carrier
4 cover film
5 packaging machine
6 container
7 conveying device
8 separating device
9 movable transport container
10 filling station
11 sealing station

1.-13. (canceled)

14. An individual blister pack (1) for medication administration, having
a carrier (3), the carrier (3) having
a plurality of recesses (2) arranged in a matrix-like manner, and
a cover film (4) for closing the recesses (2),
wherein at least two of the recesses (2) are provided substantially independently of one another and are only connected to one another by the cover film (4) and/or a defined number of connection points.

15. The blister pack (1) according to claim 14,
wherein the recesses (2) are arranged in form of at least one 1×n, 2×n, 3×n, 4×n, 5×n or 7×n matrix,
where n is a positive integer.

16. The blister pack (1) according to claim 15,
wherein two rows of the matrix are provided substantially independently of one another.

17. The blister pack (1) according to claim 14,
wherein the recesses (2) are provided such that they are separable from one another by punchings and/or perforations.

18. A packaging machine (5) for producing individual blister packs (1) for medication administration, comprising:
a filling station (10) having a plurality of containers (6), wherein each container (6) is provided for storing and dispensing a predetermined medication; and
a conveying device (7), wherein the conveying device (7) is provided for conveying a carrier (3) of a blister pack (1),
wherein the packaging machine (5) is configured such that, in the filling station (10), the medications can be filled directly from the containers (6) into the recesses (2) of the carrier (3).

19. The packaging machine (5) according to claim 18,
wherein the conveying device (7) is provided for conveying at least one movable transport container (9),
wherein the packaging machine (5) is configured such that, in the filling station (10), the medications can be filled directly from the containers (6) into the transport container (9),
wherein the packaging machine (5) comprises a transfer station,
wherein the packaging machine (5) is configured such that, in the transfer station, the medications can be transferred from the movable transport container (9) into a recess (2) of a carrier (3) of a blister pack (1) associated with the transport container (9).

20. The packaging machine according to claim 19,
further comprising a sealing station (11),
wherein the sealing station (11) is arranged immediately after the filling station (10) or the transfer station, and
wherein the sealing station (11) is set up for sealing a cover film (4) onto the carrier (3).

21. The packaging machine (5) according to claim 20,
further comprising a separating device (8) for separating a predetermined length of the blister pack (1) and/or the carrier (3),
wherein the separating device (8) is arranged before or after the filling station (10), the transfer station and/or the sealing station (11).

22. The packaging machine (5) according claim 19,
further comprising a cleaning station,
wherein the cleaning station is arranged after the transfer station,
wherein the cleaning station is set up for cleaning the at least one transport container (9) and/or the container (6).

23. The packaging machine (5) according to claim 18,
wherein the carriers (3) are made available by different machines and have a tablet, a powder, an ointment and/or a liquid.

24. The packaging machine (5) according to claim 18,
wherein the containers (6) are automatically interchangeably and/or fillable.

25. A method for producing an individual blister pack (1) for medication administration,
wherein, in a first step, a carrier (3) is provided having a plurality of recesses (2) arranged in a matrix-like manner,
wherein, in a second step, the recesses (2) are automatically filled with medications,
wherein, in a third step, immediately after filling, a cover film (4) is sealed onto the carrier (3), and
wherein at least two recesses are connected (2) substantially only through the cover film (4).

26. The method according to claim 25,
wherein, in the second step, the medications are filled directly through containers (6) into the recesses (2) or
wherein in
a first sub-step of the second step, the medications are placed in at least one movable transport container (9) and wherein in
a second sub-step, the medications are transferred from the transport container (9) into at least one predetermined recess (2) in the carrier (3).

27. The method according to claim 25, wherein the method is carried out using a packaging machine (5) comprising:
a filling station (10) having a plurality of containers (6), wherein each container (6) is provided for storing and dispensing a predetermined medication; and
a conveying device (7), wherein the conveying device (7) is provided for conveying a carrier (3) of a blister pack (1),
wherein the packaging machine (5) is configured such that, in the filling station (10), the medications can be filled directly from the containers (6) into the recesses (2) of the carrier (3).
